(19) United States
(12) Patent Application Publication
(10) Pub. No.: US 2025/0246768 A1
(43) Pub. Date: Jul. 31, 2025

(54) Electrical Connection Module and Electrical Connection Assembly

(71) Applicant: Tyco Electronics (Shanghai) Co., Ltd., Shanghai (CN)

(72) Inventors: Yu Zhang, Shanghai (CN); Xiao (Nichee) Zhou, Shanghai (CN); You Zhou, Shanghai (CN)

(73) Assignee: Tyco Electronics (Shanghai) Co., Ltd., Shanghai (CN)

(21) Appl. No.: 19/041,318

(22) Filed: Jan. 30, 2025

(30) Foreign Application Priority Data
Jan. 30, 2024 (CN) 202410132352.6

(51) Int. Cl. H01M 50/517; H01M 50/209; H01M 50/507; H01R 4/48

(52) U.S. Cl. CPC H01M 50/517; H01M 50/209; H01M 50/507; H01R 4/4863; H01R 4/489

(57) ABSTRACT

An electrical connection module includes an electrical connection member having a receiving cavity and a contact spring arranged therein. The electrical connection member has an outer peripheral wall surrounding the receiving cavity, and a top wall and a bottom opening opposite to the top wall in an axial direction of the receiving cavity. The contact spring is annular in shape and is adapted to be fit as a ring onto a conductive post of a connected object inserted from the bottom opening. The contact spring is adapted to undergo elastic deformation along a radial direction of the receiving cavity to establish radial electrical contact with the inserted conductive post.

### CROSS-REFERENCE TO RELATED APPLICATION

This application claims the benefit of Chinese Patent Application No. CN202410132352.6 filed on Jan. 30, 2024, in the State Intellectual Property Office of China, the whole disclosure of which is incorporated herein by reference.

### FIELD OF THE DISCLOSURE

The disclosure relates to an electrical connection module and an electrical connection assembly comprising the electrical connection module.

### BACKGROUND OF THE INVENTION

In the prior art, when using busbars as conductive conductors, the contact surfaces of such electrical conduction systems are in plane to plane contact, and may be fixed with bolts or laser welding. The bolt fixing method is mainly used for equipment connections, while laser welding is widely used in battery packs and is an irreversible or permenant.

For the electrical connections between a bus bar and a piece of equipment, an electrical connection structure at the bus bar end is floatable, while the electrical connection structure at the equipment end is fixed and secured to the electrical connection structure at the equipment end using bolts. For example, in the application example of a contact device.

Still referring to the prior art, for the electrical connections between busbars, the electrical connection structures at both ends of the busbars may be floatable. Bolts may be used to lock the electrical connection structures at both ends of the busbars, for example, in the application example of a cabinet.

For the electrical connections between the bus bar and a pole of a rechargeable battery cell, the electrical connection structure at the bus bar end is floatable, and the pole at the battery cell end is fixed. The electrical connection structure at the bus bar end may be welded to the pole at the battery cell end by laser welding, for example, in the application example of a battery pack.

Finally, in the prior art, when using flat to flat electrical contact methods, poor electrical contact can occur in environments prone to vibration. However, when permanent welding is used, the inability to achieve insertion and removal functions is inconvenient.

### SUMMARY OF THE INVENTION

According to an embodiment of the present disclosure, an electrical connection module includes an electrical connection member having a receiving cavity and a contact spring arranged therein. The electrical connection member has an outer peripheral wall surrounding the receiving cavity, and a top wall and a bottom opening opposite to the top wall in an axial direction of the receiving cavity. The contact spring is annular in shape and is adapted to be fit as a ring onto a conductive post of a connected object inserted from the bottom opening. The contact spring is further adapted to undergo elastic deformation along a radial direction of the receiving cavity to make radial electrical contact with the inserted conductive post.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of an electrical connection assembly according to a first embodiment of the present invention;

FIG. 2 shows a cross-sectional view of the electrical connection assembly shown in FIG. 1;

FIG. 3 shows an illustrative exploded view of the electrical connection assembly according to the first embodiment of the present invention;

FIG. 4 shows an illustrative perspective view of the contact spring of the electrical connection assembly according to the first embodiment of the present invention;

FIG. 5 shows a cross-sectional view of the electrical connection assembly shown in FIG. 3;

FIG. 6 shows an illustrative perspective view of an electrical connection assembly according to a second embodiment of the present invention;

FIG. 7 shows a cross-sectional view of the electrical connection assembly shown in FIG. 6;

FIG. 8 shows an illustrative exploded view of the electrical connection assembly according to the second embodiment of the present invention;

FIG. 9 shows an illustrative perspective view of the contact spring of the electrical connection assembly according to the second embodiment of the present invention;

FIG. 10 shows a cross-sectional view of the electrical connection assembly shown in FIG. 8;

FIG. 11 shows an illustrative perspective view of an electrical connection assembly according to a third embodiment of the present invention;

FIG. 12 shows an illustrative perspective view of an electrical connection module according to a third embodiment of the present invention;

FIG. 13 shows a cross-sectional view of an electrical connection module according to a third embodiment of the present invention; and

FIG. 14 shows an illustrative exploded view of an electrical connection module according to a third embodiment of the present invention.

### DETAILED DESCRIPTION

Hereinafter, embodiments will be described in detail with reference to the accompanying drawing. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, an electrical connection module comprises an electrical connection member formed with a receiving cavity, and a contact spring which is provided in the receiving cavity. The electrical connection member has an outer peripheral wall surrounding the receiving cavity, as well as a top wall and a bottom opening opposite to the top wall in an axial direction of the receiving cavity. The contact spring is annular in shape so as to be able to be fitted like a ring onto a conductive post of a connected object inserted from the bottom opening. The contact spring is adapted to undergo elastic deformation along a radial direction of the receiving cavity to make radial electrical contact with the inserted conductive post, so that the electrical connection member is capable of being electrically connected to the connected object via the contact spring.

According to another embodiment of the present disclosure, there is provided an electrical connection assembly. The electrical connection assembly comprises the above electrical connection module, and a connected object which has a conductive post for electrical connection. The conductive post is inserted into the receiving cavity of the electrical connection member. The contact spring is fitted onto the inserted conductive post and in electrical contact with the conductive post to electrically connect the electrical connection member to the connected object via the contact spring.

### First Embodiment

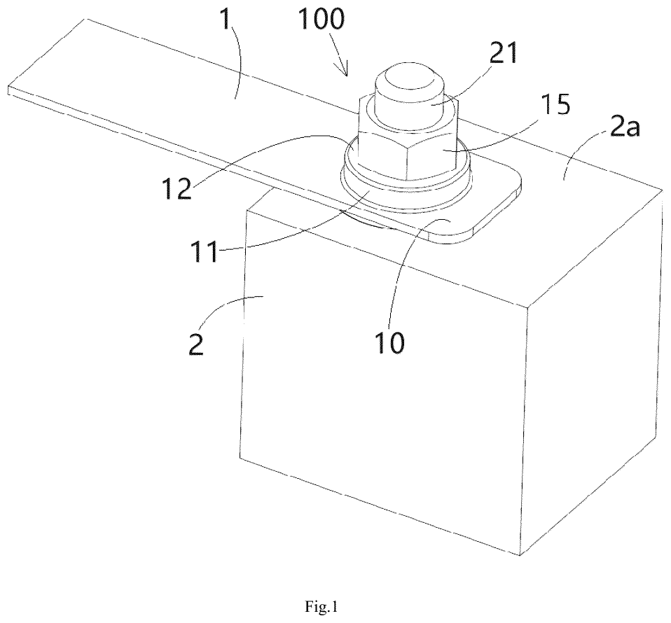

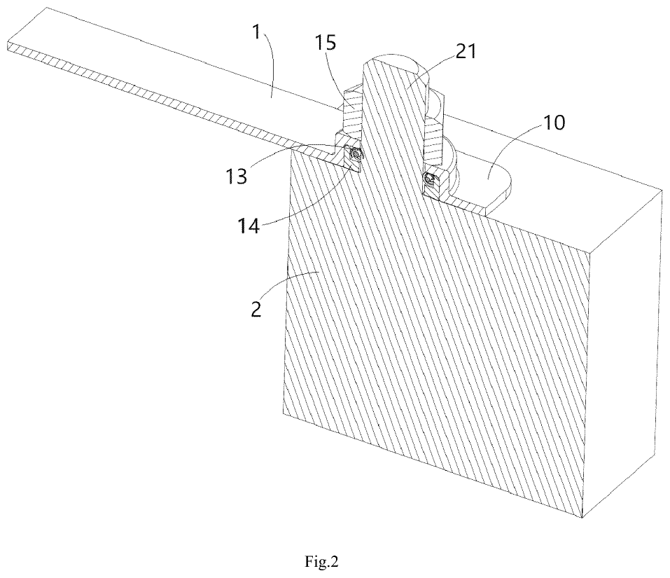

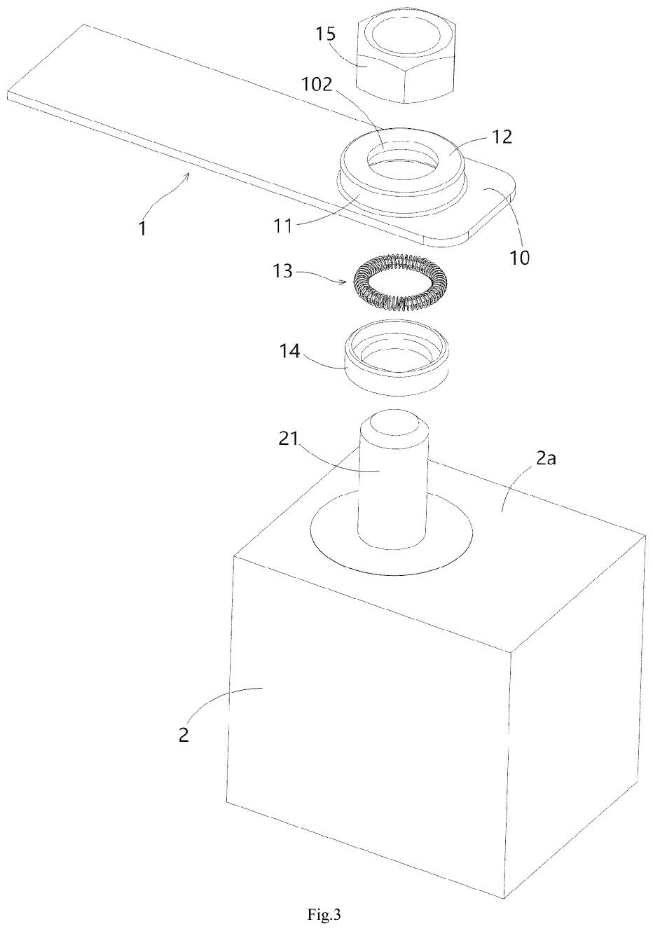

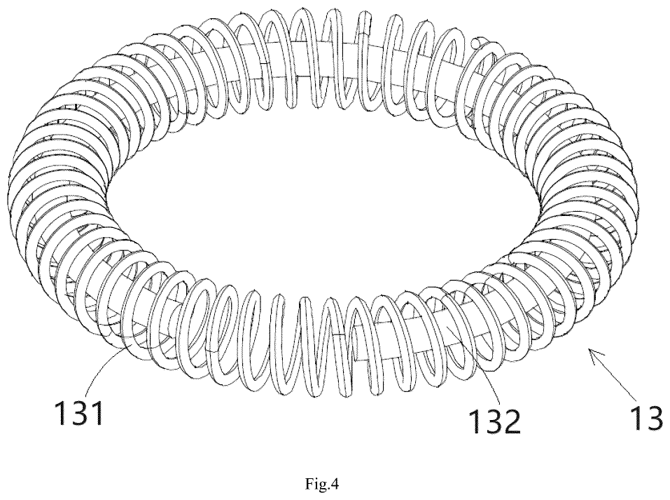

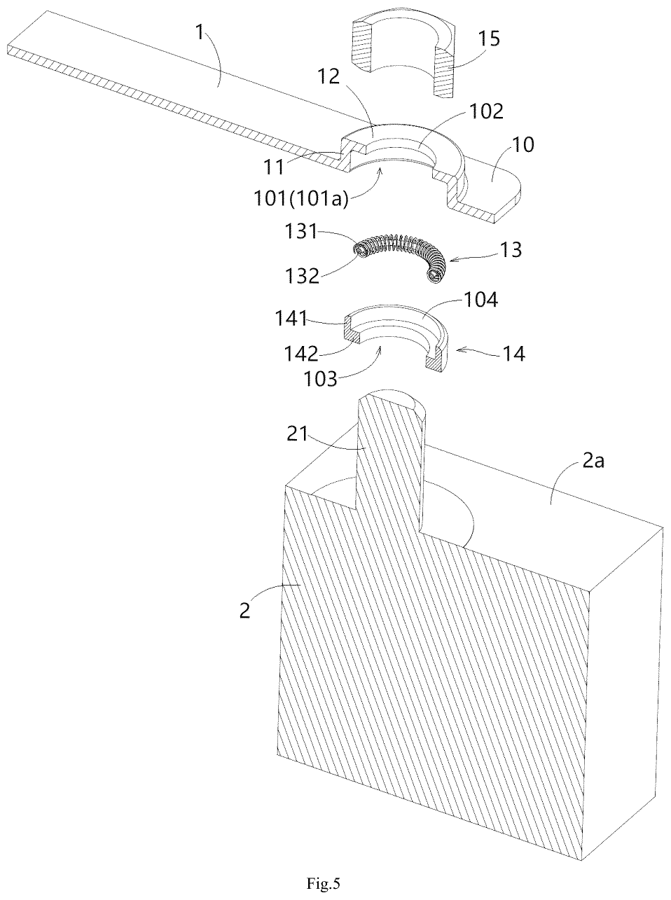

FIGS. 1-5 show a first embodiment according to the present invention. Specifically, FIG. 1 shows an illustrative perspective view of the electrical connection assembly according to the first embodiment of the present invention. FIG. 2 shows a cross-sectional view of the electrical connection assembly shown in FIG. 1. FIG. 3 shows an illustrative exploded view of the electrical connection assembly according to the first embodiment of the present invention. FIG. 4 shows an illustrative perspective view of the contact spring of the electrical connection assembly according to the first embodiment of the present invention. FIG. 5 shows a cross-sectional view of the electrical connection assembly shown in FIG. 3.

As shown in FIGS. 1-5, in an exemplary embodiment of the present disclosure, an electrical connection module 100 is disclosed. The electrical connection module 100 includes an electrical connection member 1 and a contact spring 13. A receiving cavity 101 is formed in the electrical connection member 1. The contact spring 13 is set in the receiving cavity 101 of the electrical connection member 1. The electrical connection member 1 has an outer peripheral wall 11 surrounding the receiving cavity 101, as well as a top wall 12 and a bottom opening 101a that are opposite to each other in the axial direction of the receiving cavity 101.

The contact spring 13 is annular so as to be able to be fitted onto a conductive post 21 of a connected object 2 inserted from the bottom opening 13a like a ring. The contact spring 13 is adapted to undergo elastic deformation along the radial direction of the receiving cavity 101, so as to be able to make radial electrical contact with the inserted conductive post 21. This enables the electrical connection member 1 to be electrically connected to the connected object 2 via the contact spring 13. A top through-hole 102 is formed in the top wall 12 of the receiving cavity 101 to allow the conductive post 21 to pass through, so that the conductive post 21 inserted from the bottom opening 101a of the receiving cavity 101 can pass through the top wall 12 of the receiving cavity 101 through the top through-hole 102.

In the illustrated embodiment, the electrical connection module 100 further includes a limiting element 14, which is annular in shape and installed in the receiving cavity 101. The limiting element 14 limits the contact spring 13 in the axial direction of the receiving cavity 101 to prevent the contact spring 13 from being moved in the axial direction of the receiving cavity 101. The limiting element 14 has a peripheral wall portion 141, a bottom wall 142, and a top opening 104. A bottom through-hole 103 is formed in the bottom wall 142 of the limiting element 14 to allow the conductive post 21 to pass through. The bottom wall 142 of the limiting element 14 and the top wall 12 of the receiving cavity 101 are opposite in the axial direction of the receiving cavity 101 and respectively rest on the upper and lower sides of the contact spring 13, so that the contact spring 13 cannot be moved in the axial direction of the receiving cavity 101.

The outer peripheral surface of the peripheral wall portion 141 of the limiting element 14 is in interference fit with the inner peripheral surface of the outer peripheral wall 11 of the receiving cavity 101 to fix the limiting element 14 in the receiving cavity 101. Before the conductive post 21 is inserted into the contact spring 13, there is a predetermined gap between the contact spring 13 and the peripheral wall portion 141 of the limiting element 14 to allow the contact spring 13 to float radially in the receiving cavity 101. In this way, it can absorb errors caused by significant manufacturing, installation, or thermal expansion. After the conductive post 21 is inserted into the contact spring 13, the contact spring 13 is expanded by the conductive post 21 in the radial direction of the receiving cavity 101 and comes into contact with the peripheral wall portion 141 of the limiting element 14. In another exemplary embodiment, before the conductive post 21 is inserted into the contact spring 13, the contact spring 13 comes into contact with the peripheral wall portion 141 of the limiting element 14.

Still referring to FIGS. 1-5, in the illustrated embodiment, the top surface of the peripheral wall portion 141 of the limiting element 14 is pressed against the inner side of the top wall 12 of the receiving cavity 101. The bottom wall 142 of the limiting element 14 is adapted to be pressed against the top surface 2a of the connected object 2, so as to be able to position the limiting element 14 in the axial direction of the receiving cavity 101.

The electrical connection member 1 has a flat connecting portion 10, the outer peripheral wall 11 of the receiving cavity 101 protrudes from the top surface of the flat connecting portion 10. The bottom surface of the flat connection portion 10 is adapted to rest against the top surface 2a of the connected object 2, and the bottom opening 101a of the receiving cavity 101 is located on the bottom surface of the flat connection portion 10.

The electrical connection module 100 further comprises a nut 15, which is adapted to be threaded onto a conductive post 21 that passes through the top wall 12 of the receiving cavity 101, to fasten the electrical connection module 100 to the top surface 2a of the connected object 2. When the electrical connection module 100 is fastened to the top surface 2a of the connected object 2, the nut 15 is pressed against the outer side of the top wall 12 of the receiving cavity 101. When the electrical connection module 100 is fastened to the top surface 2a of the connected object 2, the bottom surface of the electrical connection member 1 is pressed against the top surface 2a of the connected object 2 or tilted at a predetermined angle relative to the top surface of the connected object 2.

The contact spring 13 includes a coil spring 131 and a C-shaped elastic ring 132. The coil spring 131 is coiled into a ring shape to fit on the conductive post 21. The C-shaped elastic ring 132 is set in the coil spring 131. The coil spring 131 is used to make electrical contact with the conductive post 21, and the C-shaped elastic ring 132 is used to provide auxiliary contact force to the coil spring 131 to improve the electrical contact force between the coil spring 131 and the conductive post 21. However, the contact spring 13 of the present invention is not limited to the illustrated embodiment. For example, in another exemplary embodiment of the present invention, the contact spring 13 may include a spring plate that is wavy and coiled into a ring shape to be suitable for being fitted onto the conductive post 21.

As shown in FIGS. 1-5, in another exemplary embodiment of the present invention, an electrical connection assembly is disclosed. The electrical connection assembly includes an electrical connection module 100 and a connected object 2. The connected object 2 has a conductive post 21 for electrical connection. The conductive post 21 is inserted into the receiving cavity 101 of the electrical connection member 1. The contact spring 13 is fitted onto the inserted conductive post 21 and in electrical contact with it, to electrically connect the electrical connection member 1 to the connected object 2 via the contact spring 13.

In the illustrated embodiment, the connected object 2 has a top surface 2a, and the conductive post 21 extends upward from the top surface 2a of the connected object 2 by a predetermined height and is threaded at the end of the conductive post 21. The conductive post 21 passes through the top through-hole 102 in the top wall 12 of the receiving cavity 101 and is threaded with a nut 15 to fasten the electrical connection module 100 to the top surface 2a of the connected object 2.

In the illustrated embodiment, the electrical connection member 1 is a bus bar, the connected object 2 is an electrical device, and the bus bar is electrically connected to the electrical device via the contact spring 13. A single receiving cavity 101 is formed in the electrical connection member 1. The electrical connection module 100 is used to electrically connect with the conductive post 21 on a single connected object 2.

### Second Embodiment

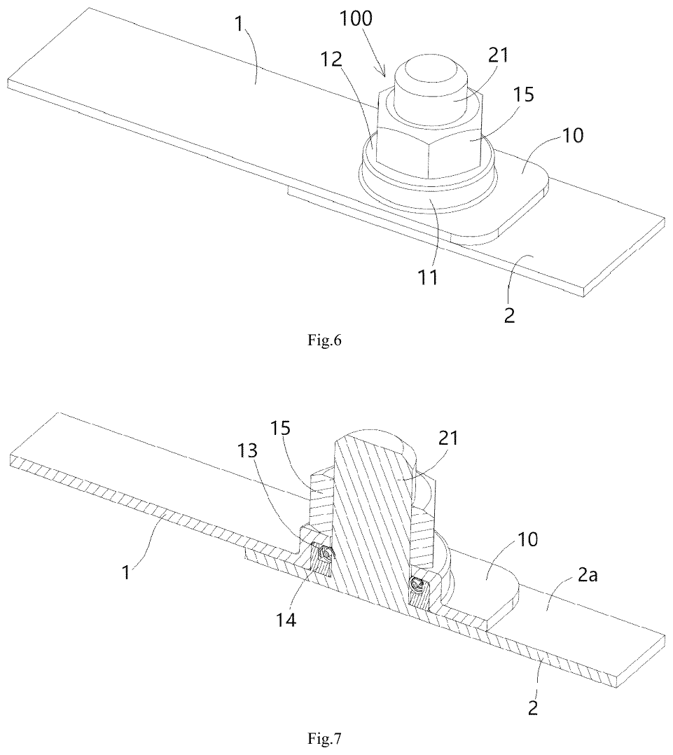

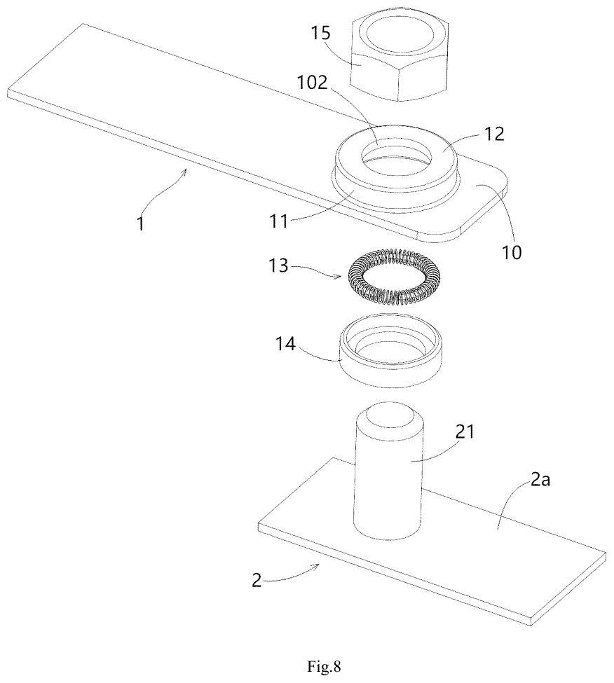

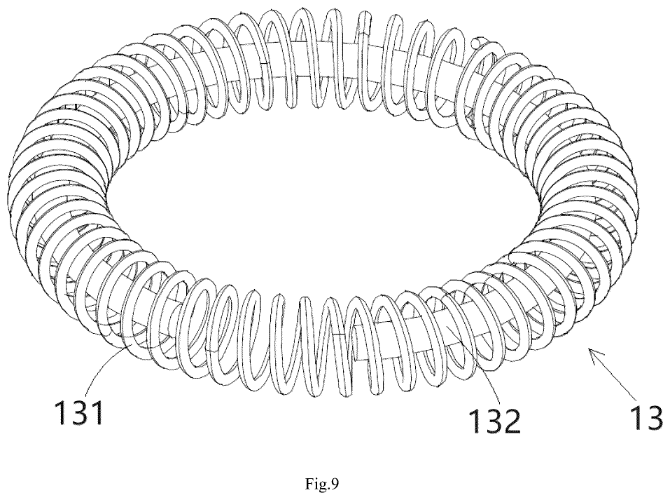

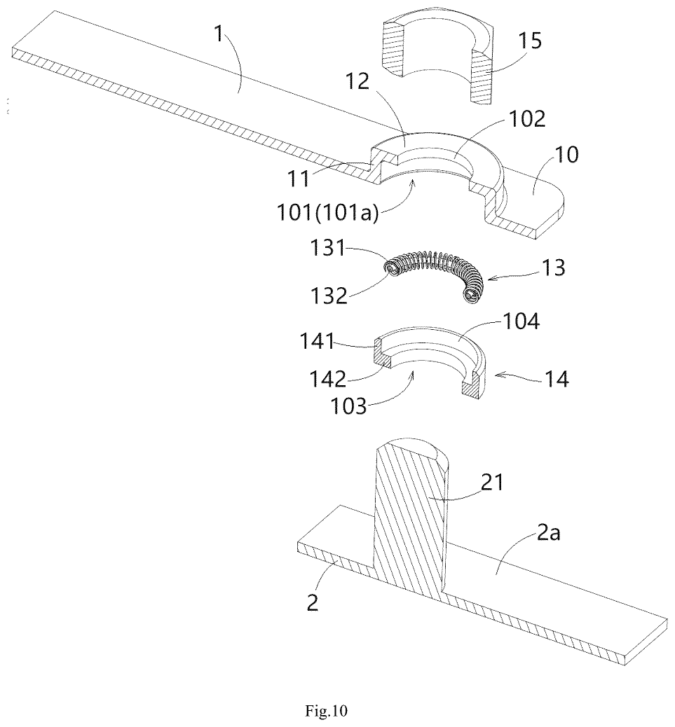

FIGS. 6-10 show a second embodiment according to the present disclosure. Specifically, FIG. 6 shows an illustrative perspective view of the electrical connection assembly according to the second embodiment of the present invention. FIG. 7 shows a cross-sectional view of the electrical connection assembly shown in FIG. 6. FIG. 8 shows an illustrative exploded view of the electrical connection assembly according to the second embodiment of the present invention. FIG. 9 shows an illustrative perspective view of the contact spring of the electrical connection assembly according to the second embodiment of the present invention. FIG. 10 shows a cross-sectional view of the electrical connection assembly shown in FIG. 8.

As shown in FIGS. 6-10, in an exemplary embodiment of the present disclosure, an electrical connection module 100 is disclosed. The electrical connection module 100 includes an electrical connection member 1 and a contact spring 13. A receiving cavity 101 is formed in the electrical connection member 1. The contact spring 13 is set in the receiving cavity 101 of the electrical connection member 1. The electrical connection member 1 has an outer peripheral wall 11 surrounding the receiving cavity 101, as well as a top wall 12 and a bottom opening 101a that are opposite to each other in the axial direction of the receiving cavity 101.

The contact spring 13 is annular so as to be able to be fitted onto the conductive post 21 of the connected object 2 inserted from the bottom opening 14a like a ring. The contact spring 13 is adapted to undergo elastic deformation along the radial direction of the receiving cavity 101, so as to be able to make radial electrical contact with the inserted conductive post 21, enabling the electrical connection member 1 to be electrically connected to the connected object 2 via the contact spring 13. A top through-hole 102 is formed in the top wall 12 of the receiving cavity 101 to allow the conductive post 21 to pass through, so that the conductive post 21 inserted from the bottom opening 101a of the receiving cavity 101 can pass through the top wall 12 of the receiving cavity 101 through the top through-hole 102.

The electrical connection module 100 further includes a limiting element 14, which is annular in shape and installed in the receiving cavity 101 for limiting the contact spring 13 in the axial direction of the receiving cavity 101 to prevent the contact spring 13 from being moved in the axial direction of the receiving cavity 101. The limiting element 14 has a peripheral wall portion 141, a bottom wall 142, and a top opening 104. A bottom through-hole 103 is formed in the bottom wall 142 of the limiting element 14 to allow the conductive post 21 to pass through. The bottom wall 142 of the limiting element 14 and the top wall 12 of the receiving cavity 101 are opposite in the axial direction of the receiving cavity 101 and respectively rest on the upper and lower sides of the contact spring 13, so that the contact spring 13 cannot be moved in the axial direction of the receiving cavity 101.

The outer peripheral surface of the peripheral wall portion 141 of the limiting element 14 is in interference fit with the inner peripheral surface of the outer peripheral wall 11 of the receiving cavity 101 to fix the limiting element 14 in the receiving cavity 101. Before the conductive post 21 is inserted into the contact spring 13, there is a predetermined gap between the contact spring 13 and the peripheral wall portion 141 of the limiting element 14 to allow the contact spring 13 to float radially in the receiving cavity 101. In this way, it can absorb errors caused by significant manufacturing, installation, or thermal expansion. After the conductive post 21 is inserted into the contact spring 13, the contact spring 13 is expanded by the conductive post 21 in the radial direction of the receiving cavity 101 and comes into contact with the peripheral wall portion 141 of the limiting element 14. Before the conductive post 21 is inserted into the contact spring 13, the contact spring 13 comes into contact with the peripheral wall portion 141 of the limiting element 14. In the illustrated embodiment, the top surface of the peripheral wall portion 141 of the limiting element 14 is pressed against the inner side of the top wall 12 of the receiving cavity 101, and the bottom wall 142 of the limiting element 14 is adapted to be pressed against the top surface 2a of the connected object 2, so as to be able to position the limiting element 14 in the axial direction of the receiving cavity 101.

The electrical connection member 1 has a flat connecting portion 10, the outer peripheral wall 11 of the receiving cavity 101 protrudes from the top surface of the flat connecting portion 10. The bottom surface of the flat connection portion 10 is adapted to rest against the top surface 2a of the connected object 2, and the bottom opening 101a of the receiving cavity 101 is located on the bottom surface of the flat connection portion 10.

The electrical connection module 100 further includes a nut 15, which is suitable for threaded connection to the conductive post 21 that passes through the top wall 12 of the receiving cavity 101, to fasten the electrical connection module 100 to the top surface 2a of the connected object 2. When the electrical connection module 100 is fastened to the top surface 2a of the connected object 2, the nut 15 is pressed against the outer side of the top wall 12 of the receiving cavity 101.

When the electrical connection module 100 is fastened to the top surface 2a of the connected object 2, the bottom surface of the electrical connection member 1 is pressed against the top surface 2a of the connected object 2 or tilted at a predetermined angle relative to the top surface of the connected object 2.

The contact spring 13 includes a coil spring 131 and a C-shaped elastic ring 132. The coil spring 131 is coiled into a ring shape to fit over the conductive post 21. The C-shaped elastic ring 132 is set in the coil spring 131. The coil spring 131 is used to make electrical contact with the conductive post 21, and the C-shaped elastic ring 132 is used to provide auxiliary contact force to the coil spring 131 to improve the electrical contact force between the coil spring 131 and the conductive post 21. However, please note that the contact spring 13 of the present invention is not limited to the illustrated embodiment. For example, in another exemplary embodiment of the present invention, the contact spring 13 may include a spring plate that is wavy and coiled into a ring shape to be suitable for being placed on the conductive post 21.

As shown in FIGS. 6 to 10, in another exemplary embodiment of the present invention, an electrical connection assembly is disclosed. The electrical connection assembly includes an electrical connection module 100 and a connected object 2. The connected object 2 has a conductive post 21 for electrical connection. The conductive post 21 is inserted into the receiving cavity 101 of the electrical connection member 1, and the contact spring 13 is fitted onto the inserted conductive post 21 and in electrical contact with it, to electrically connect the electrical connection member 1 to the connected object 2 via the contact spring 13.

The connected object 2 has a top surface 2a, and the conductive post 21 extends upward from the top surface 2a of the connected object 2 by a predetermined height and is threaded at the end of the conductive post 21. The conductive post 21 passes through the top through-hole 102 in the top wall 12 of the receiving cavity 101 and is threaded with the nut 15 to fasten the electrical connection module 100 to the top surface 2a of the connected object 2.

In the illustrated embodiment, electrical connection member 1 is a first bus bar, the connected object 2 is a second bus bar, and the first bus bar is electrically connected to the second bus bar via the contact spring 13. A single receiving cavity 101 is formed in the electrical connection member 1. The electrical connection module 100 is used to electrically connect with the conductive post 21 on a single connected object 2.

### Third Embodiment

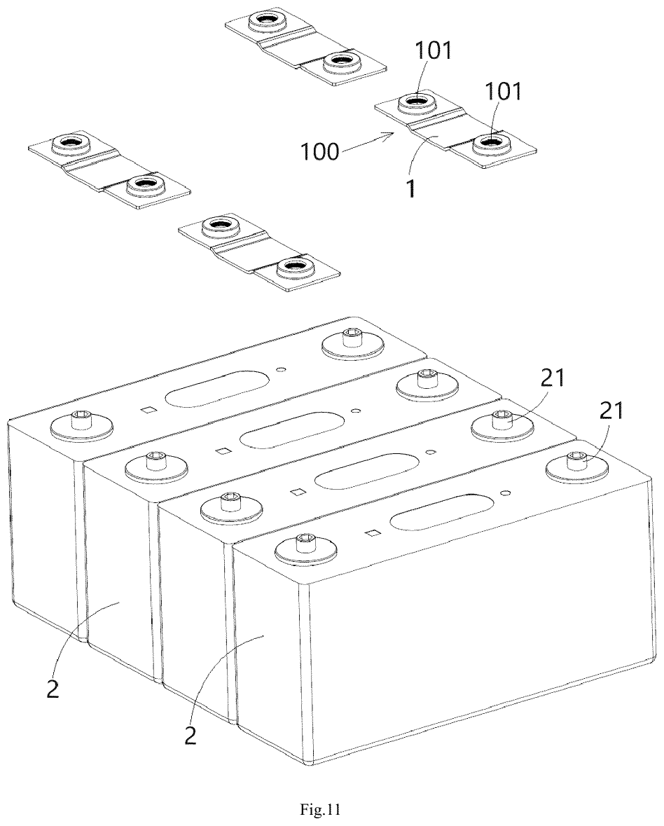

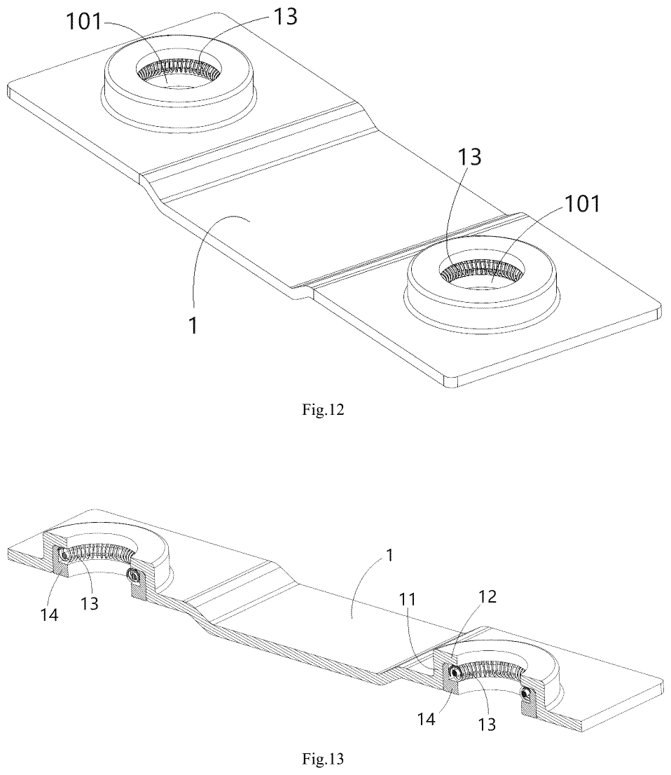

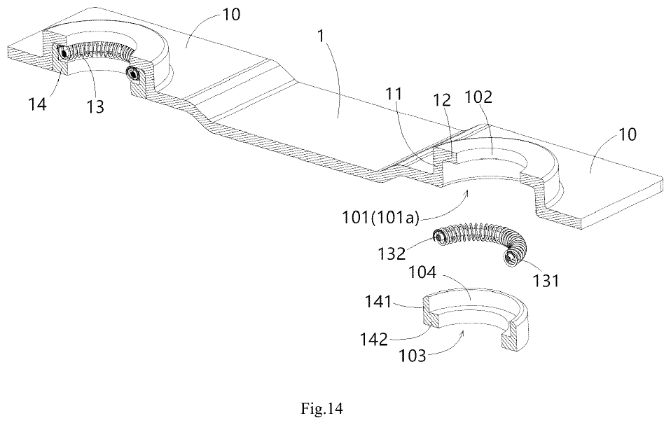

FIGS. 11-14 show a third embodiment according to the present disclosure. Among them, FIG. 11 shows an illustrative perspective view of an electrical connection assembly according to a third embodiment of the present invention. FIG. 12 shows an illustrative perspective view of an electrical connection module 100 according to a third embodiment of the present invention. FIG. 13 shows a cross-sectional view of an electrical connection module 100 according to a third embodiment of the present invention. FIG. 14 shows an illustrative exploded view of an electrical connection module according to a third embodiment of the present invention.

As shown in FIGS. 11-14, in an exemplary embodiment of the present invention, an electrical connection module 100 is disclosed. The electrical connection module 100 includes an electrical connection member 1 and a contact spring 13. A receiving cavity 101 is formed in the electrical connection member 1. The contact spring 13 is set in the receiving cavity 101 of the electrical connection member 1. The electrical connection member 1 has an outer peripheral wall 11 surrounding the receiving cavity 101, as well as a top wall 12 and a bottom opening 101a that are opposite to each other in the axial direction of the receiving cavity 101.

The contact spring 13 is annular so as to be able to be fitted onto the conductive post 21 of the connected object 2 inserted from the bottom opening 14a like a ring. The contact spring 13 is adapted to undergo elastic deformation along radial direction of the receiving cavity 101, so as to be able to make radial electrical contact with the inserted conductive post 21, enabling the electrical connection member 1 to be electrically connected to the connected object 2 via the contact spring 13. A top through-hole 102 is formed in the top wall 12 of the receiving cavity 101 to allow the conductive post 21 to pass through, so that the conductive post 21 inserted from the bottom opening 101a of the receiving cavity 101 can pass through the top wall 12 of the receiving cavity 101 through the top through-hole 102.

The electrical connection module 100 further includes a limiting element 14, which is annular in shape and installed in the receiving cavity 101 for limiting the contact spring 13 in the axial direction of the receiving cavity 101 to prevent the contact spring 13 from being moved in the axial direction of the receiving cavity 101. The limiting element 14 has a peripheral wall portion 141, a bottom wall 142, and a top opening 104. A bottom through-hole 103 is formed in the bottom wall 142 of the limiting element 14 to allow the conductive post 21 to pass through. The bottom wall 142 of the limiting element 14 and the top wall 12 of the receiving cavity 101 are opposite in the axial direction of the receiving cavity 101 and respectively rest on the upper and lower sides of the contact spring 13, so that the contact spring 13 cannot be moved in the axial direction of the receiving cavity 101. The outer peripheral surface of the peripheral wall portion 141 of the limiting element 14 is in interference fit with the inner peripheral surface of the outer peripheral wall 11 of the receiving cavity 101 to fix the limiting element 14 in the receiving cavity 101.

Before the conductive post 21 is inserted into the contact spring 13, there is a predetermined gap between the contact spring 13 and the peripheral wall portion 141 of the limiting element 14 to allow the contact spring 13 to float radially in the receiving cavity 101. In this way, it can absorb errors caused by significant manufacturing, installation, or thermal expansion. After the conductive post 21 is inserted into the contact spring 13, the contact spring 13 is expanded by the conductive post 21 in the radial direction of the receiving cavity 101 and comes into contact with the peripheral wall portion 141 of the limiting element 14. Before the conductive post 21 is inserted into the contact spring 13, the contact spring 13 comes into contact with the peripheral wall portion 141 of the limiting element 14. In the illustrated embodiment, the top surface of the peripheral wall portion 141 of the limiting element 14 is pressed against the inner side of the top wall 12 of the receiving cavity 101, and the bottom wall 142 of the limiting element 14 is adapted to be pressed against the top surface of the connected object 2, so as to be able to position the limiting element 14 in the axial direction of the receiving cavity 101.

The electrical connection member 1 has a flat connecting portion 10, the outer peripheral wall 11 of the receiving cavity 101 protrudes from the top surface of the flat connecting portion 10. The bottom surface of the flat connection portion 10 is adapted to rest against the top surface of the connected object 2, and the bottom opening 101a of the receiving cavity 101 is located on the bottom surface of the flat connection portion 10.

As shown in FIGS. 11-14, in the illustrated embodiment, the contact spring 13 includes a coil spring 131 and a C-shaped elastic ring 132 (see FIGS. 4 and 9). The coil spring 131 is coiled into a ring shape to be fitted onto the conductive post 21. The C-shaped elastic ring 132 is set in the coil spring 131. The coil spring 131 is used to make electrical contact with the conductive post 21, and the C-shaped elastic ring 132 is used to provide auxiliary contact force to the coil spring 131 to improve the electrical contact force between the coil spring 131 and the conductive post 21. However, please note that the contact spring 13 of the present invention is not limited to the illustrated embodiment. For example, in another exemplary embodiment of the present invention, the contact spring 13 may include a spring plate that is wavy and coiled into a ring shape to be suitable for being fitted onto the conductive post 21.

Still referring to FIGS. 11-14, in another exemplary embodiment of the present invention, an electrical connection assembly is disclosed. The electrical connection assembly includes an electrical connection module 100 and a connected object 2. The connected object 2 has a conductive post 21 for electrical connection. The conductive post 21 is inserted into the receiving cavity 101 of the electrical connection member 1, and the contact spring 13 is fitted onto the inserted conductive post 21 and in electrical contact with it, to electrically connect the electrical connection member 1 to the connected object 2 via the contact spring 13.

Multiple receiving cavities 101 are formed in the electrical connection member 1, and the electrical connection module 100 includes multiple contact springs 13 respectively arranged in the multiple receiving cavities 101, for electrically connecting with the conductive posts 21 on the multiple connected objects 2 to electrically interconnect the conductive posts 21 on the multiple connected objects 2.

The electrical connection module 100 further includes multiple limiting elements 14 respectively arranged in multiple receiving cavities 101, for preventing multiple contact springs 13 from being moved in the axial direction of the receiving cavity 101. In the illustrated embodiment, the electrical connection member 1 is a bus bar, the connected object 2 is a rechargeable battery cell, the conductive post 21 is the electrode end of the battery cell, and the bus bar is electrically connected to the battery cell via the contact spring 13.

Receiving cavities 101 are formed at both ends of the electrical connection member 1, and the electrical connection module 100 includes two contact springs 13 respectively arranged in the receiving cavities 101 at both ends of the electrical connection member 1. The electrical connection assembly includes multiple electrical connection modules 100 and multiple battery cells. The electrode ends of adjacent battery cells are respectively inserted into the receiving cavities 101 at both ends of the electrical connection member 1, so that the electrode ends of adjacent battery cells are electrically interconnected.

However, please note that the present invention is not limited to the illustrated embodiment. For example, in another exemplary embodiment of the present invention, the electrical connection member 1 is a bus bar, the connected object 2 is a rechargeable battery cell, the conductive post 21 is the electrode end of the battery cell, and the bus bar is electrically connected to the battery cell via the contact spring 13.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. An electrical connection module, comprising:
an electrical connection member defining a receiving cavity, including:
an outer peripheral wall surrounding the receiving cavity;
a top wall; and
a bottom opening opposite the top wall in an axial direction of the receiving cavity; and
an annular contact spring arranged in the receiving cavity and adapted to receive a conductive post of a connected object insert through the bottom opening, the contact spring adapted to undergo elastic deformation along a radial direction of the receiving cavity and establish radial electrical contact with the inserted conductive post, so that the electrical connection member is electrically connected to the connected object via the contact spring.

2. The electrical connection module according to claim 1, wherein a top through hole is formed in the top wall of the receiving cavity and adapted to permit the conductive post to pass therethrough.

3. The electrical connection module according to claim 1, further comprising an annular limiting element arranged in the receiving cavity and limiting movement of the contact spring in the axial direction of the receiving cavity.

4. The electrical connection module according to claim 3, wherein:
the limiting element has a peripheral wall portion, a bottom wall, and a top opening, a bottom through-hole is formed in the bottom wall of the limiting element and adapted to receive the conductive post therethrough;
the bottom wall of the limiting element and the top wall of the receiving cavity are opposite in the axial direction of the receiving cavity and respectively abut upper and lower sides of the contact spring limiting movement of the contact spring in the axial direction.

5. The electrical connection module according to claim 4, wherein an outer peripheral surface of the peripheral wall portion of the limiting element is interference fit with an inner peripheral surface of the outer peripheral wall of the receiving cavity to fix the limiting element in the receiving cavity.

6. The electrical connection module according to claim 5, wherein prior to insertion of the conductive post into the contact spring, a predetermined gap is defined between the contact spring and the peripheral wall portion of the limiting element to allow the contact spring to float radially in the receiving cavity.

7. The electrical connection module according to claim 6, the receiving cavity is sized such that, after the conductive post is inserted into the contact spring, the contact spring is adapted to be expanded by the conductive post in the radial direction of the receiving cavity and comes into contact with the peripheral wall portion of the limiting element.

8. The electrical connection module according to claim 4, wherein the top surface of the peripheral wall portion of the limiting element is pressed against the inner side of the top wall of the receiving cavity, and the bottom wall of the limiting element is adapted to be pressed against the top surface of the connected object to be able to position the limiting element in the axial direction of the receiving cavity.

9. The electrical connection module according to claim 1, wherein:
the electrical connection member has a flat connection portion, the outer peripheral wall of the receiving cavity protrudes from the top surface of the flat connection portion; and
the bottom surface of the flat connection portion is adapted to rest against the top surface of the connected object, and the bottom opening of the receiving cavity is located on the bottom surface of the flat connection portion.

10. The electrical connection module according to claim 1, further comprising a nut adapted to threadably engage with the conductive post passing through the top wall of the receiving cavity to fasten the electrical connection module to the top surface of the connected object.

11. The electrical connection module according to claim 1, wherein the contact spring comprises:
a spiral spring which is coiled into a ring shape; and
a C-shaped elastic ring installed in the spiral spring, the spiral spring is adapted to make electrical contact with the conductive post, and the C-shaped elastic ring is adapted to provide auxiliary contact force to the spiral spring to improve the electrical contact force between the spiral spring and the conductive post.

12. The electrical connection module according to claim 1, wherein a single receiving cavity is formed in the electrical connection member, and the electrical connection module adapted to electrically connect with a conductive post on a single connected object.

13. The electrical connection module according to claim 1, wherein multiple receiving cavities are formed in the electrical connection member, and the electrical connection module comprises multiple contact springs respectively arranged in the multiple receiving cavities, for electrically connecting with conductive posts on multiple connected objects to electrically interconnect the conductive posts on the multiple connected objects.

14. The electrical connection module according to claim 13, wherein the electrical connection module further comprises multiple limiting elements respectively arranged in the multiple receiving cavities, for respectively preventing the multiple contact springs from being moved in the axial direction of the receiving cavity.

15. An electrical connection assembly, comprising:
a connected object having a conductive post for electrical connection; and
an electrical connection module, comprising:
an electrical connection member defining a receiving cavity, including:
an outer peripheral wall surrounding the receiving cavity;
a top wall; and
a bottom opening opposite the top wall in an axial direction of the receiving cavity; and
an annular contact spring arranged in the receiving cavity and receiving the conductive post of the connected object insert through the bottom opening, the contact spring elastically deforming along a radial direction of the receiving cavity and establishing radial electrical contact with the inserted conductive post, so that the electrical connection member is electrically connected to the connected object via the contact spring.

16. The electrical connection assembly according to claim 15, wherein:
the connected object has a top surface, and the conductive post extends upward from the top surface of the connected object by a predetermined height and has a thread formed on the end of the conductive post; and
the conductive post passes through the top through-hole in the top wall of the receiving cavity and is threaded with a nut to fasten the electrical connection module to the top surface of the connected object.

17. The electrical connection assembly according to claim 15, wherein the electrical connection member is a first bus bar, the connected object is a second bus bar, and the first bus bar is electrically connected to the second bus bar via the contact spring.

18. The electrical connection assembly according to claim 15, wherein the electrical connection member is a bus bar, and the connected object is an electrical device, the bus bar is electrically connected to the electrical device via the contact spring.

19. The electrical connection assembly according to claim 15, wherein the electrical connection member is a bus bar, the connected object is a rechargeable battery cell, the conductive post is an electrode end of the battery cell, and the bus bar is electrically connected to the battery cell via the contact spring.

20. The electrical connection assembly according to claim 19, wherein:
the two ends of the electrical connection member are respectively formed with the receiving cavities, and the electrical connection module comprises two contact springs respectively arranged in the receiving cavities at both ends of the electrical connection member; and
the electrical connection assembly comprises multiple electrical connection modules and multiple battery cells, the electrode ends of adjacent battery cells are respectively inserted into the receiving cavities at both ends of the electrical connection member, so that the electrode ends of adjacent battery cells are electrically interconnected.
